(19) United States
(12) Patent Application Publication
(10) Pub. No.: US 2023/0142872 A1
(43) Pub. Date: May 11, 2023

(54) IN-FLIGHT EMERGENCY EVACUATION SYSTEM

(71) Applicant: Aymen Alfadil, Aberdeen (GB)

(72) Inventor: Aymen Alfadil, Aberdeen (GB)

(21) Appl. No.: 17/522,962

(22) Filed: Nov. 10, 2021

(51) Int. Cl. B64D 25/10; B64D 11/06

(52) U.S. Cl. CPC B64D 25/10; B64D 11/0616; B64D 11/0696

(57) ABSTRACT

The invention provides an in-flight emergency evacuation system in an aircraft which has a seating area comprising of plurality of rows of passenger seats which are positioned on plurality of rails. The passenger seats are slidably movable on the rails. The system further discloses at least one emergency room which is configured to accommodate the passenger seats inside it during an emergency condition for safely ejecting the passengers outside of the emergency rooms. During an emergency condition, the crew members of the aircraft can hit the evacuation button which automatically starts the evacuation process. Once the evacuation button is pressed, the slidably movable motorized passenger seats which are positioned on the rails starts moving in a sequential manner into the emergency room which is capable of accommodating one row of passenger seats at a time and ejecting it outside the aircraft.

### FIELD OF THE INVENTION

The present invention is directed generally to aircraft safety and emergency systems and, more specifically, to an in-flight evacuation system for rescuing passengers in passenger aircraft from air crashes.

### BACKGROUND OF THE INVENTION

Background description includes information that may be useful in understanding the present invention. It is not an admission that any of the information provided herein is prior art or relevant to the presently claimed invention, or that any publication specifically or implicitly referenced is prior art.

The safety of aircraft passenger has been a concern from the beginning of aviation. Planes crash for a variety of reasons, including pilot error, mechanical error, weather, etc. Often, it is the case that the pilot is aware that his or her plane is in trouble and is going to crash or is in danger of crashing. However, in many such cases, there is little the pilot can do to ensure his or her safety as well as the safety of the passengers.

One of today’s greatest airline concerns is airplane safety. This concern is due to a high number of airplane crashes in the recent past. Although these crashes have many different causes, the result usually ends in loss of life. Due to the major effect that these crashes have of the general public, the public’s safety and well being has become more important as each crash occurs.

US20210039766 A1 discloses a rescue solution for the passengers of a plane. The evacuation system comprises an aircraft having safety room existing luggage area and kitchen area of an airplane which can be used for passengers in-case of emergency, detachably coupling said safety room from said airplane and releasing of said safety room. By opening said at least one parachute, the passengers will slowly ascend to earth safely.

US6776373 B1 discloses that an Aircraft Escape (AEC) is designed for manned atmospheric or space vehicles having a fly-away capability at any time during the flight of the parent aircraft. The AEC houses the crew, passengers, life support systems, aircraft flight controls, propulsion, navigation instruments, communications equipment, and deceleration devices to permit safe landing of the escape cabin on land or water. A rocket or mechanical device provides the means to actively separate the escape cabin from the parent aircraft during an emergency.

RU2171206 C1 discloses a method that consists of using at least one rescue capsule which forms passenger cabin. Capsule is placed in one-piece fuselage and includes parachute with doorways. Elongated shaped charges are located in fuselage along its case and over circle between pilot cabin, rescue capsule and tail section. During evacuation, doorways of rescue capsule are closed and explosive cutting of case by shaped charges is effected for separation of rescue capsule from pilot cabin, tail section and skin of fuselage and parachute is developed.

The existing in-flight evacuation system are very complex and requires very complex designing of the aircraft structures which may affect the overall efficiency of the aircrafts, including the flying efficiency. Moreover, the existing in-flight evacuation systems are time consuming and involves manual procedures. Hence, they cannot be relied upon in emergency situations as time plays a vital role in such emergency situations and in a panic state of mind, the passengers may not be able to duly follow the manual evacuation procedures in an emergency situation.

To date, stable ejection seats have been made which include encapsulating seats, electable cockpits to protect the crew during escape at supersonic speeds, however, no in-flight evacuation system has been produced with the ability to eject the passenger seats in a sequential manner to offer quick and safe egress of the passengers from the aircraft in case of an emergency. The present application provides these and other advantages as will be apparent from the following detailed description and accompanying figures.

### SUMMARY OF THE INVENTION

This summary is provided to introduce a selection of concepts in a simplified format that are further described in the detailed description of the present disclosure. This summary is not intended to identify key or essential inventive concepts of the present disclosure, nor is it intended for determining the scope of the present disclosure.

It is an object of the invention to provide an in-flight emergency evacuation system in an aircraft for rescuing passengers in passenger aircraft from air crashes.

It is another object of the invention to provide an in-flight emergency evacuation system in an aircraft for rescuing passengers which provides ejection of passenger seats sequentially to offer quick and safe egress of the passengers from the aircraft in case of an emergency.

It is another object of the invention to provide an in-flight emergency evacuation system which requires minimum manual intervention.

It is another object of the invention to provide an in-flight emergency evacuation system which requires lesser and simple modifications in the basic structure of the aircraft.

According to an embodiment of the present disclosure, the in-flight emergency evacuation system of the aircraft comprises a seating area having a plurality of rows of passenger seats positioned on both the sides of at least one walkway passing through the middle of a seating area of the aircraft, at least one emergency rooms positioned between the proximal and distal ends on the left or right direction before a column of the passenger seats of the aircraft respectively. Further, it comprises a first rail and a second rail placed on floor panel in the seating area of the aircraft. Each row of the passenger seats comprises a set of three movable seats coupled with each other and positioned on the first and second rails and at least two seatbelts are present to fasten the passenger to the seats during the emergency evacuation. It further comprises a first automatic door configured to provide entry to the passenger seats inside the emergency rooms and a second automatic door configured to eject the passenger seats outside the aircraft via the emergency rooms. The second rail is perpendicular and movably connected to the first rail configured to selectively move the plurality of rows of passenger seats along both the first and the second rail in horizontal and longitudinal directions. Each row of the passenger seats sequentially slides inside the emergency room via the first automatic door during the emergency evacuation and further the system comprises at least one heavy-duty Kevlar® domed parachute positioned underneath a middle seat of each row of the passenger seats configured to open during the ejection of the passenger seats outside the aircraft via the second automatic door of the emergency rooms.

According to an embodiment of the present disclosure, the emergency rooms of the aircraft are designed to accommodate each row of passenger seats at a time.

According to an embodiment of the present disclosure, the second automatic door opens in a side direction for ejecting each row of the passenger seat outside the aircraft in case of an emergency.

According to an embodiment of the present disclosure, each row of the passenger seats comprises an independent set of motors and a plurality of sliding mechanisms/rollers which slidably move the passenger seats along both the first and the second rail in horizontal and longitudinal direction.

According to an embodiment of the present disclosure, the system comprises a portable oxygen device for each passenger configured to store and supply oxygen to the passengers during the emergency evacuation.

According to an embodiment of the present disclosure, the portable oxygen device is connected to an oxygen mask placed in a lower pouch of each passenger seat.

According to an embodiment of the present disclosure, each row of the passenger seats comprises a protective shield holder configured to deploy a protective shield to completely encapsulate the passenger seats, isolating the passengers from the outer environment.

According to an embodiment of the present disclosure, the protective shield is made up of a highly conductive material.

According to an embodiment of the present disclosure, each row of the passenger seats comprises an airbag underneath the passenger seats configured to inflate during the emergency evacuation to absorb shock during the landing on the ground. The airbag is capable of floating on water.

According to an embodiment of the present disclosure, the first and second automatic door is a sliding door.

According to an embodiment of the present disclosure, each row of the passenger seat is equipped with a radio, at least one rechargeable battery, and a Global Positioning System module for locating the passengers after the safe emergency exit from the aircraft.

According to an embodiment of the present invention, the floor of the emergency room comprises at least one bar movably fixed on the floor of the emergency room configured to push each row of the passenger seat outside the aircraft via the second automatic door.

To further clarify the advantages and features of the present disclosure, a more particular description of the disclosure will be rendered by reference to specific embodiments thereof, which is illustrated in the appended drawings. It is appreciated that these drawings depict only typical embodiments of the disclosure and are therefore not to be considered limiting of its scope. The disclosure will be described and explained with additional specificity and detail with the accompanying drawings.

### BRIEF DESCRIPTION OF THE DRAWINGS

The subject matter that is regarded as the invention is particularly pointed out and distinctly claimed in the claims at the conclusion of the specification. The foregoing and other aspects, features, and advantages of the invention are apparent from the following detailed description taken in conjunction with the accompanying drawings in which:

FIG. 1 illustrates a schematic view of the aircraft comprising the in-flight emergency evacuation system, in accordance with an embodiment of the present disclosure.

FIG. 2 illustrates a schematic view of the passenger seats, in accordance with an embodiment of the present disclosure.

FIG. 3 illustrates a schematic view of the passenger seats with an open parachute, in accordance with an embodiment of the present disclosure.

FIG. 4 illustrates a schematic view of the emergency room, in accordance with an embodiment of the present disclosure.

FIG. 5 illustrates a schematic view of the movable passenger seats positioned on the rails, in accordance with an embodiment of the present disclosure.

FIG. 6 illustrates an exploded view of the movable passenger seats positioned on the rails, in accordance with an embodiment of the present disclosure.

Further, skilled artisans will appreciate that elements in the drawings are illustrated for simplicity and may not have necessarily been drawn to scale. Furthermore, in terms of the construction of the device, one or more components of the device may have been represented in the drawings by conventional symbols, and the drawings may show only those specific details that are pertinent to understanding the embodiments of the present invention so as not to obscure the drawings with details that will be readily apparent to those of ordinary skill in the art having benefit of the description herein.

### DETAILED DESCRIPTION OF THE INVENTION

For the purpose of promoting an understanding of the principles of the invention, reference will now be made to the embodiment illustrated in the drawings, and specific language will be used to describe the same. It will nevertheless be understood that no limitation of the scope of the invention is thereby intended. Such alterations and further modifications in the illustrated system, and such further applications of the principles of the invention as illustrated therein would be contemplated as would normally occur to one skilled in the art to which the invention relates. Unless otherwise defined, all technical and scientific terms used herein have the same meaning as commonly understood by one of ordinary skilled in the art. The system, methods, and examples provided herein are illustrative only and are not intended to be limiting.

The term “some” as used herein is to be understood as “none or one or more than one or all.” Accordingly, the terms “none,” “one,” “more than one,” “more than one, but not all” or “all” would all fall under the definition of “some.” The term “some embodiments” may refer to no embodiments or to one embodiment or to several embodiments or to all embodiments, without departing from the scope of the present disclosure.

The terminology and structure employed herein is for describing, teaching, and illuminating some embodiments and their specific features. It does not in any way limit, restrict or reduce the spirit and scope of the claims or their equivalents.

More specifically, any terms used herein such as but not limited to “includes,” “comprises,” “has,” “consists,” and grammatical variants thereof do not specify an exact limitation or restriction and certainly do not exclude the possible addition of one or more features or elements, unless otherwise stated, and furthermore must not be taken to exclude the possible removal of one or more of the listed features and elements, unless otherwise stated with the limiting language “must comprise” or “needs to include.”

Whether or not a certain feature or element was limited to being used only once, either way, it may still be referred to as “one or more features” or “one or more elements” or “at least one feature” or “at least one element.” Furthermore, the use of the terms “one or more” or “at least one” feature or element do not preclude there being none of that feature or element, unless otherwise specified by limiting language such as “there needs to be one or more ... ” or “one or more element is required.”

Unless otherwise defined, all terms, and especially any technical and/or scientific terms, used herein may be taken to have the same meaning as commonly understood by one having ordinary skills in the art.

Reference is made herein to some “embodiments.” It should be understood that an embodiment is an example of a possible implementation of any features and/or elements presented in the attached claims. Some embodiments have been described for the purpose of illuminating one or more of the potential ways in which the specific features and/or elements of the attached claims fulfill the requirements of uniqueness, utility and non-obviousness.

Use of the phrases and/or terms including, but not limited to, “a first embodiment,” “a further embodiment,” “an alternate embodiment,” “one embodiment,” “an embodiment,” “multiple embodiments,” “some embodiments,” “other embodiments,” “further embodiment”, “furthermore embodiment”, “additional embodiment” or variants thereof do not necessarily refer to the same embodiments. Unless otherwise specified, one or more particular features and/or elements described in connection with one or more embodiments may be found in one embodiment, or may be found in more than one embodiment, or may be found in all embodiments, or may be found in no embodiments. Although one or more features and/or elements may be described herein in the context of only a single embodiment, or alternatively in the context of more than one embodiment, or further alternatively in the context of all embodiments, the features and/or elements may instead be provided separately or in any appropriate combination or not at all. Conversely, any features and/or elements described in the context of separate embodiments may alternatively be realized as existing together in the context of a single embodiment.

Any particular and all details set forth herein are used in the context of some embodiments and therefore should not be necessarily taken as limiting factors to the attached claims. The attached claims and their legal equivalents can be realized in the context of embodiments other than the ones used as illustrative examples in the description below.

Embodiments of the present invention will be described below in detail with reference to the accompanying drawings.

The present invention provides an in-flight emergency evacuation system of the aircraft. It has a seating area which comprises of plurality of rows of passenger seats which are positioned on plurality of rails. These passenger seats are slidably movable on these rails. The system further discloses at least one emergency room which is configured to accommodate the passenger seats inside it during an emergency condition for safely ejecting the passengers outside of the emergency rooms. During an emergency condition, the crew members of the aircraft can hit the evacuation button which automatically starts the evacuation process. Once the evacuation button is pressed, the slidably movable motorized passenger seats which are positioned on the rails starts moving in a sequential manner into the emergency room, the emergency room is capable of accommodating one row of passenger seats at a time and ejecting it outside the aircraft. Each row of passenger seats may have capacity of upto two to four passengers.

The other rows of the passenger seats are kept on hold until a row of passenger seats is present inside the emergency room. The other row of passenger seats moves inside the emergency room only when the status of the emergency room is vacant, i.e., a row of passenger seats have been ejected outside of the aircraft. The same process is repeated again and again until every passenger seats have been evacuated safely from the aircraft. Each row of passenger seats has its own parachute which ensures the safe landing of the passengers.

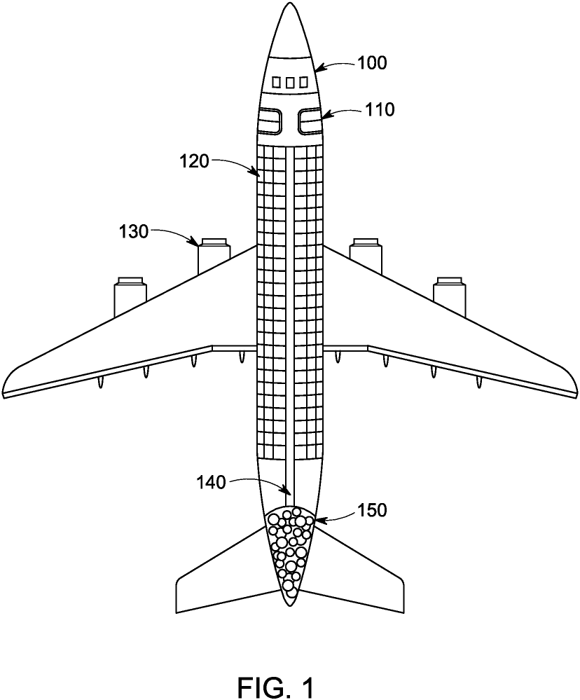

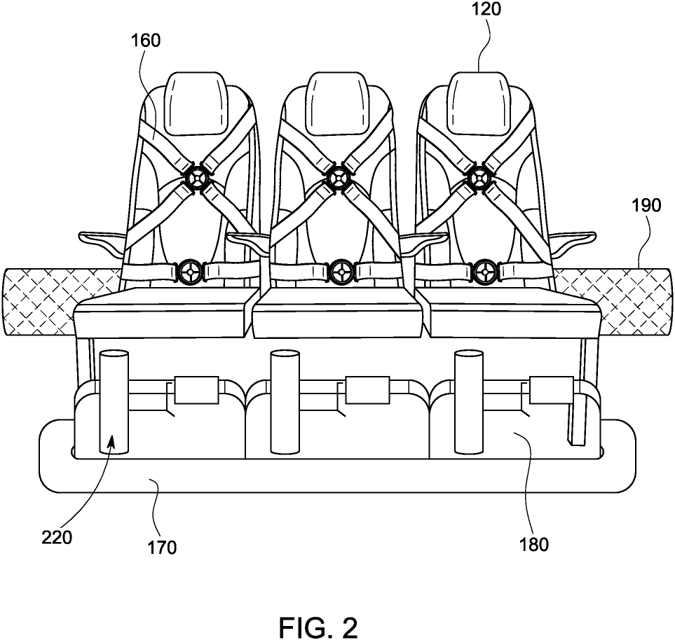

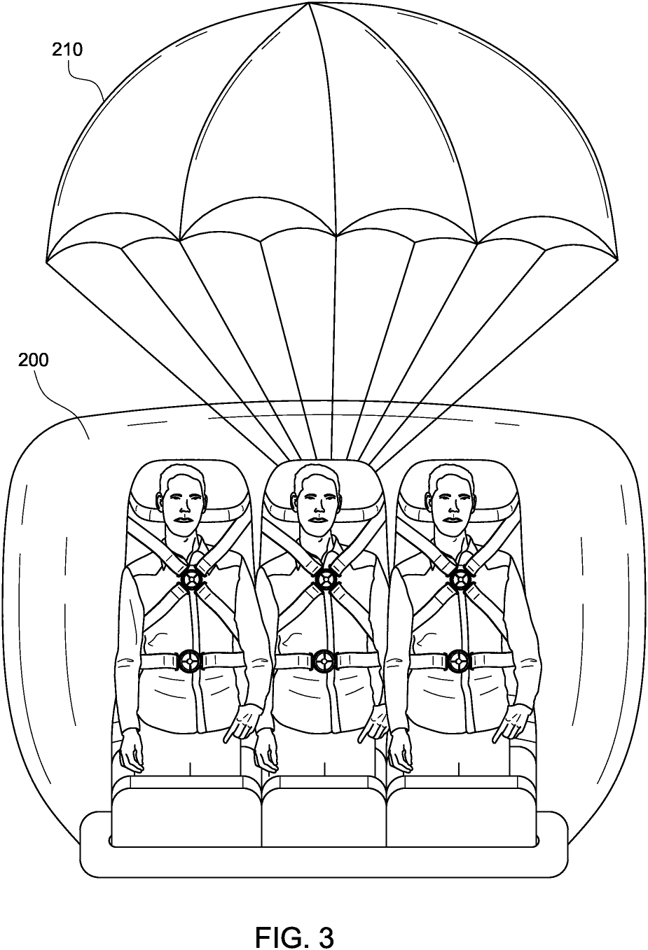

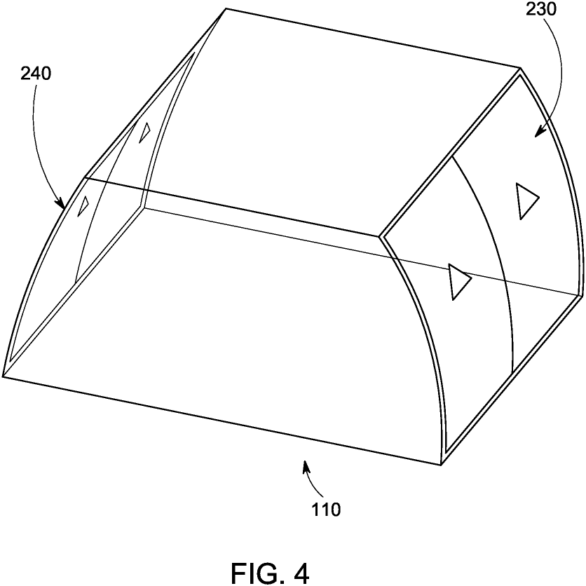

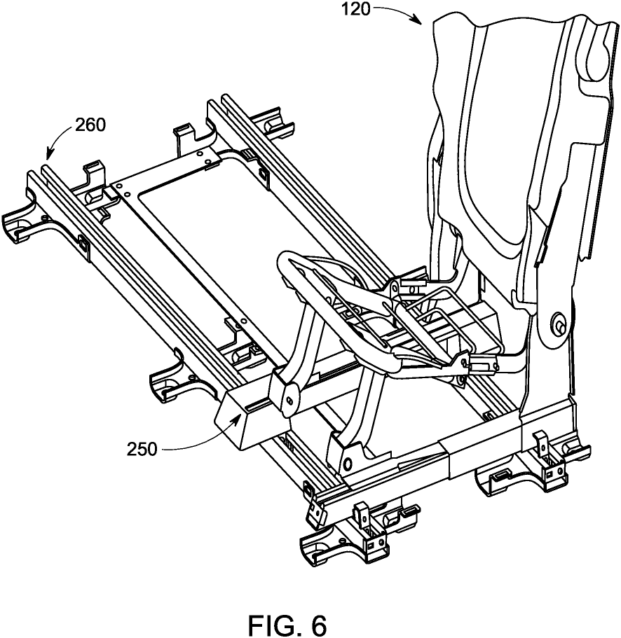

The present invention provides an in-flight emergency evacuation system of the aircraft as shown in FIG. 1 which comprises a seating area having a plurality of rows of passenger seats 120 positioned on both the sides of at least one walkway 140 passing through the middle of a seating area of the aircraft, at least one emergency rooms 110 positioned between the proximal and distal ends on the left or right direction before a column of the passenger seats 120 of the aircraft respectively. Further, it comprises a first rail 250 and a second rail 260 as shown in FIG. 6, placed on the floor panel in the seating area of the aircraft. Each row of the passenger seat 120 comprises a set of three movable seats coupled with each other and positioned on the first and second rails 260 and at least two seatbelts 160 as shown in FIG. 2 are present to fasten the passenger to the seats during the emergency evacuation. It further comprises a first automatic door 240 as shown in FIG. 4, configured to provide entry to the passenger seats 120 inside the emergency rooms 110 and a second automatic door 230 as shown in FIG. 4, configured to eject the passenger seats 120 outside the aircraft via the emergency rooms 110. The second rail 260 is perpendicular and movably connected to the first rail 250 configured to selectively move the plurality of rows of passenger seats 120 along with both the first and the second rail 260 in horizontal and longitudinal directions. Each row of the passenger seats 120 sequentially slides inside the emergency room via the first automatic door 240 during the emergency evacuation and further the system comprises at least one heavy-duty Kevlar® domed parachute 210 as shown in FIG. 3, positioned underneath a middle seat of each row of the passenger seats 120 configured to open during the ejection of the passenger seats 120 outside the aircraft via the second automatic door 230 of the emergency rooms 110. The emergency rooms are positioned behind the cockpit area (100). The walkway 140 of the aircraft extends till the luggage section 150 of the aircraft.

In an embodiment of the present disclosure, the emergency rooms 110 as shown in FIG. 4 of the aircraft are designed to accommodate each row of passenger seats 120 at a time. The emergency room accommodates and ejects each row of passenger seats 120 outside the aircraft one by one in a sequential manner. The level of the first automatic door 240 and the second automatic door 230 of the emergency rooms 110 is below the level of the turbine engines 130 which eliminates the risks of fatal injuries to the passengers during the evacuation process.

In an embodiment of the present disclosure, the second automatic door 230 opens in a side direction for ejecting each row of the passenger seat outside the aircraft in case of an emergency.

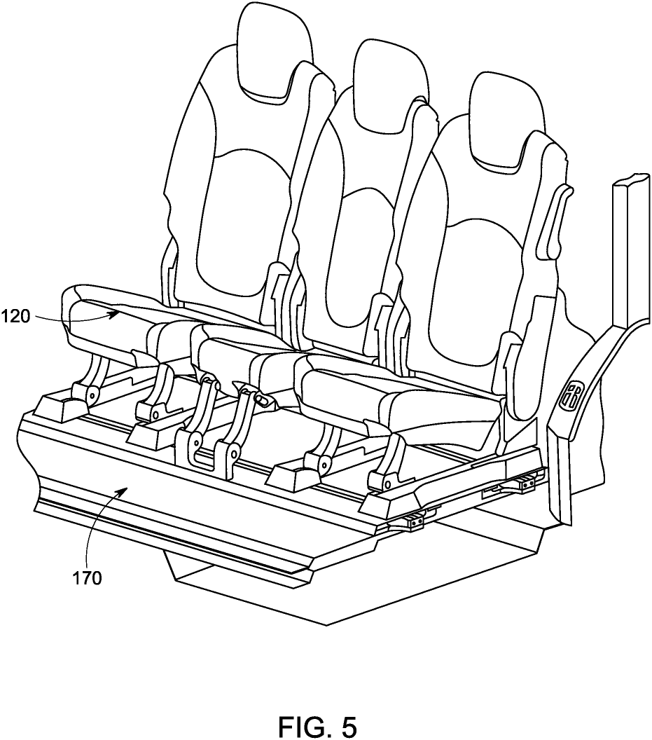

Referring to FIG. 5 and FIG. 6, in an embodiment of the present disclosure, each row of the passenger seats 120 comprises an independent set of motors and a plurality of sliding mechanisms/rollers which slidably move the passenger seats 120 along both the first and the second rail 260 in the horizontal and longitudinal direction. The passenger seats 120 are movably connected to the first rail 250, and a second seat is mounted with respect to the first rail 250. A second rail 260 perpendicular to the first rail 250 is movably connected to the first rail 250 so that the passenger seat 120 is selectively movable along both the first 250 and the second rail 260; therefore it is movable in two directions (vertical and horizontal). A first direction of movement is through a pair of transverse tracks or rails created, which are configured to be attached to the aircraft floor panel. At the transversal rails are two longitudinal tracks or rails leading to the transversal rails are substantially perpendicular, movable, or slidably mounted. The longitudinal rails create a second direction of movement.

The rails may be formed as tracks, with the rollers are in the tracks, or they can be shaped so that the rollers slide along the outside of the rail or track. Furthermore, rails or tracks could be used as grooves in the floor panel of the aircraft.

In an embodiment of the present disclosure, the system comprises a portable oxygen device for each passenger configured to store and supply oxygen to the passengers during the emergency evacuation. The portable oxygen device 220 is connected to an oxygen mask placed in a lower pouch 180 of each passenger seat. The pouch 180 is located just above the footrest 170 of the passenger seats 120.

In an embodiment of the present disclosure, each row of the passenger seats 120 comprises a protective shield holder 190 as shown in FIG. 2 configured to deploy a protective shield as shown in FIG. 3 to completely encapsulate the passenger seats 120, isolating the passengers from the outer environment. There is a lever present on the protective shield holder 190 which works in conjunction with the parachute 210 and it deploys the protective shield 200 outside the protective shield holder 190 completely encapsulating the passengers simultaneously when the parachute 210 opens during the free fall of the passenger seats 120. There is plurality of grooves present below the footrest 170 of the passengers seats 120 which holds the protective shield 200 in open position for encapsulating the passengers sitting on the passenger seats 120.

Referring to FIG. 3, in an embodiment of the present disclosure, the protective shield 200 is made up of a highly conductive and thick material which protects the passengers from lightning. If in case lightning strikes the passenger seats 120 which is coming down via a parachute 210, the thick conductive layer of the protective shield 200, current will travel through the conductive exterior skin and structures of the protective shield 200 and exit off some other extremity, such as the bottom of the passenger seats 120. The protective shield 200 of the present invention is made up of aluminum metal and is coated with silver.

In an embodiment of the present disclosure, each row of the passenger seats 120 comprises an airbag underneath the passenger seats 120 configured to inflate during the emergency evacuation to absorb shock during the landing on the ground. The airbag is capable of floating on water. After the evacuation of the passenger seats 120 from the aircraft, the landing of the passengers is dependent only on the parachute 210 and the wind direction. Therefore, the passengers may land anywhere on plane land, swamps, forests, water bodies, etc. Each row of the passenger seat is equipped with an airbag which can float on water and inflates just by pulling a string attached to it. The floatable airbag is fixed on the lower base of the bottom of each passenger row to ensure the safety of the passengers in case they land in a water body.

In an embodiment of the present disclosure, the first and second automatic door 230 is a sliding door. Automatic sliding doors of the invention uses optical or motion detection sensors to activate their motorized opening and closing functions. These sensors are mounted over the automatic door or are integrated into the door framing from above or the side. The sensors use either infrared or microwave technology to observe motion and are often used in commercial and industrial settings. The optical or motion sensor is wired to an electrified main drive train that controls a clutch mechanism attached to an auxiliary drive or cogwheel and the door panel or panels. The auxiliary drive and the doors are connected by internal belts or cables usually made from rubber that carry out the opening and closing motion of the doors.

In an embodiment of the present disclosure, each row of the passenger seat is equipped with a radio, at least one rechargeable battery, and a Global Positioning System module for locating the passengers after the safe emergency exit from the aircraft as each seat row of the passenger seat is evacuated independently with its parachute 210 which may land anywhere on the ground or in a water body. The global positioning system module makes it easier for the rescue team to locate the passengers evacuated from the aircraft and to ensure the safety of the passengers. Further, the radio which is a satellite radio phone allows the passengers to communicate with the air traffic control or to any nearest rescue station. Each row of the passenger seat 120 is also provided with a rechargeable battery apart from the batteries placed inside the global positioning system module and the satellite radio phone. The rechargeable battery can be used to replace the drained battery from the satellite radio phone or the global positioning system module.

In an embodiment of the present invention, the floor of the emergency room comprises at least one bar movably fixed on the floor of the emergency room configured to push each row of the passenger seat outside the aircraft via the second automatic door 230. The second automatic door 230 opens once a row of passenger seats 120 is in place inside the emergency room. The movably fixed bar positioned on the floor of the emergency room is triggered by the opening of the second automatic door 230 as the bar is connected to the second automatic door 230 by a mechanical spring mechanism and works in conjunction with the second automatic door 230. The bar is a solid bar made up of a metal which applies adequate force at the bottom of each row of the passenger seat 120 for pushing it outside the aircraft via the second automatic door 230.

For implementing the system disclosed in the present disclosure, a complete new design structure of the aircraft is needed which is capable of accommodating the above described system as the implementation of the disclosed system in the conventional aircrafts would be difficult. However, the modifications needed in the aircraft for implementation of the present system is only required for the interior structure of the aircraft without making any alterations to the basic aircraft structure. This emergency evacuation system described in the present disclosure will require a floor panel design of the aircraft to hold the rails 250, 260 on which the passenger seat 120 will be slidably movable. It also requires alterations to the basic passenger seat 120 structure as explained in the above paragraphs. Further, a free space will be required to install the emergency rooms 110.

The figures and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein. Moreover, the actions of any flow diagram need not be implemented in the order shown; nor do all of the acts necessarily need to be performed. Also, those acts that are not dependent on other acts may be performed in parallel with the other acts. The scope of the embodiments is by no means limited by these specific examples. Numerous variations, whether explicitly given in the specification or not, such as differences in structure, dimension, and use of material, are possible.

1. An in-flight emergency evacuation system in an aircraft, said system comprising:
a seating area having a plurality of rows of passenger seats positioned on both the sides of at least one walkway passing through the middle of a seating area of the aircraft;
at least one emergency rooms positioned between proximal and distal ends on right or left direction before the column of the passenger seats of the aircraft respectively;
a first rail and a second rail placed on floor panel in the seating area of the aircraft;
wherein each row of the passenger seats comprises a set of at least two movable seats coupled with each other and positioned on the first and second rails;
at least two seatbelts configured to fasten the passenger to the seats during the emergency evacuation;
a first automatic door configured to provide entry to the passenger seats inside the emergency rooms;
a second automatic door configured to eject the passenger seats outside the aircraft via the emergency rooms;
wherein the second rail is perpendicular and movably connected to the first rail configured to selectively move the plurality of rows of passenger seats along both the first and the second rail in horizontal and longitudinal direction;
wherein each row of the passenger seats sequentially slides inside the emergency room via the first automatic door during the emergency evacuation;
wherein the system comprises at least one heavy-duty Kevlar® domed parachute positioned underneath a middle seat of each row of the passenger seats configured to open during the ejection of the passenger seats outside the aircraft via the second automatic door of the emergency rooms.

2. The system according to claim 1, wherein the emergency rooms are configured to accommodate each row of passenger seats at a time.

3. The system according to claim 1, wherein the second automatic door opens on a side direction to eject each passenger seat outside the aircraft.

4. The system according to claim 1, wherein each row of the passenger seats comprises an independent set of motors and plurality of sliding mechanisms/rollers configured to slidably move the passenger seats along both the first and the second rail in horizontal and longitudinal direction.

5. The system according to claim 1, wherein the system comprises a portable oxygen device for each passenger configured to store and supply oxygen to the passengers during the emergency evacuation.

6. The system according to claim 5, wherein the portable oxygen device is connected to an oxygen mask placed in a lower pouch of each passenger seat.

7. The system according to claim 1, wherein each row of the passenger seats comprises a protective shield holder configured to deploy a protective shield to completely encapsulate the passenger seats, isolating the passengers from the outer environment.

8. The system according to claim 7, wherein the protective shield is made up of a highly conductive material.

9. The system according to claim 1, wherein each row of the passenger seats comprises an airbag underneath each row of the passenger seats configured to inflate during the emergency evacuation to absorb shock during the landing on the ground.

10. The system according to claim 9, wherein the airbag is capable of floating on water.

11. The system according to claim 1, wherein the first and the automatic door is a sliding door.

12. The system according to claim 1, wherein each row of the passenger seat is equipped with a radio, at least one rechargeable battery, and a Global Positioning System (GPS) module.

13. The system according to claim 1, wherein the floor of the emergency room comprises at least one bar movably fixed on floor of the emergency room configured to push each row of the passenger seat outside the aircraft via the second automatic door.
